(19) United States
(12) Patent Application Publication
(10) Pub. No.: US 2014/0015653 A1
(43) Pub. Date: Jan. 16, 2014

(54) VEHICLE APPROACH NOTIFICATION UNIT

(71) Applicant: DENSO CORPORATION, Kariya-city (JP)

(72) Inventors: Toshiaki NAKAYAMA, Miyoshi-city (JP); Koji SUZUKI, Hamamatsu-city (JP)

(73) Assignee: DENSO CORPORATION, Kariya-city (JP)

(21) Appl. No.: 13/898,833

(22) Filed: May 21, 2013

(30) Foreign Application Priority Data
Jul. 11, 2012 (JP) 2012-155981

(51) Int. Cl. B60Q 5/00

(52) U.S. Cl. CPC B60Q 5/00
USPC 340/425.5

(57) ABSTRACT

A vehicle approach notification unit is disposed in a vehicle for producing a notification sound. The vehicle approach notification unit has a speaker and a thin film. The speaker is disposed to a sound tube of a vehicle horn of the vehicle. The vehicle horn produces a resonant warning sound with a resonant frequency. The thin film partitions a space between the speaker and the sound tube. The speaker emits the notification sound into the sound tube so that the notification sound is emitted outside of the vehicle via the sound tube. The thin film restricts a sound wave having the resonant frequency from being transmitted, and allows a sound wave having a frequency producing the notification sound to be transmitted.

### CROSS REFERENCE TO RELATED APPLICATION

This application is based on Japanese Patent Application No. 2012-155981 filed on Jul. 11, 2012, the disclosure of which is incorporated herein by reference in its entirety.

### TECHNICAL FIELD

The present disclosure relates to a vehicle approach notification unit.

### BACKGROUND

Conventionally, a vehicle approach notification unit notifies pedestrians of an approach of a vehicle with a notification sound. For instance, JP-A-10-201001 discloses a vehicle approach notification unit having a dynamic speaker, which produces the notification sound with audible frequencies.

The speaker produces the notification sound to notify pedestrians of the approach of the vehicle, so the speaker needs to be disposed to a part of the vehicle to produce the notification sound outside of the vehicle. However, it is difficult to have a space in the vehicle to dispose the speaker. Especially, it is difficult to have the space on a front side of the vehicle, while the speaker may be required to be disposed on the front side of the vehicle to produce the notification sound ahead of the vehicle.

In Japanese Patent Application No. 2011-238815 (U.S. patent application Ser. No. 13/662,913), a vehicle horn, which has a trumpet portion and produces a resonant warning sound (i.e., a warning sound produced by resonance), mounts a speaker that produces a notification sound.

The vehicle horn has a sound tube (i.e., a resonant tube), and the sound tube has the speaker that produces the notification sound. The notification sound is emitted out of the vehicle via the sound tube.

A warning sound generator, which is disposed to the vehicle horn and produces a frequency producing a warning sound, produces a sound wave having a very high sound pressure. Therefore, when the warning sound generator is actuated, the resonant warning sound having the very high sound pressure is produced inside the sound tube, especially, around an inlet of the sound tube.

Accordingly, when the speaker is disposed in the sound tube, the resonant warning sound having the very high sound pressure impacts the speaker, and may break the speaker. Furthermore, a back electromotive force produced by the speaker may break a circuit such as an amplifier that actuates the speaker.

### SUMMARY

According to an example of the present disclosure, there is provided a vehicle approach notification unit disposed in a vehicle for producing a notification sound. The vehicle approach notification unit has a speaker and a thin film. The speaker is disposed to a sound tube of a vehicle horn of the vehicle. The vehicle horn produces a resonant warning sound with a resonant frequency. The thin film partitions a space between the speaker and the sound tube. The speaker emits the notification sound into the sound tube so that the notification sound is emitted outside of the vehicle via the sound tube. The thin film restricts a sound wave having the resonant frequency from being transmitted, and allows a sound wave having a frequency producing the notification sound to be transmitted.

### BRIEF DESCRIPTION OF THE DRAWINGS

Features and advantages of the present disclosure will become more apparent from the following detailed description made with reference to the accompanying drawings. In the drawings:

FIG. 1A is a cross-sectional view illustrating a vehicle approach notification unit having a speaker that produces a notification sound;

FIG. 1B is an enlarged cross-sectional view illustrating the speaker;

FIG. 2 is a front view illustrating a vehicle horn to which the speaker is mounted;

FIG. 3 is a block diagram illustrating the vehicle approach notification unit; and

FIG. 4 is a graph illustrating a relationship between a transmitted sound level and a frequency with respect to a thickness of a thin film of the vehicle approach notification unit.

### DETAILED DESCRIPTION

An embodiment employing the present disclosure will be described hereafter referring to drawings. However, it should be noted that the present disclosure is not limited to the embodiment.

A vehicle approach notification unit is disposed in a vehicle that may emit a quite sound during a drive time or a stop time. For example, the vehicle may be an electric vehicle or a fuel cell vehicle with no engine (i.e., no internal combustion engine). Also the vehicle may be a hybrid vehicle in which the engine is stopped at the drive time and the stop time, an idling stop vehicle in which the engine is stopped at the stop time, or an engine vehicle that drives quietly.

The vehicle may include a vehicle horn 2, which works as a warning unit and produces a resonant warning sound. When an occupant operates a horn switch, such as a horn button on a steering wheel, the vehicle horn 2 produces the resonant warning sound. The vehicle horn 2 may be disposed between, for example, a front grille and a heat exchanger. The front grille is located to an air intake port that receives and draws a flow of outside air generated when the vehicle drives, and the heat exchanger is used for an air-conditioner, such as radiator.

Although a mechanism of the vehicle horn 2 is not limited, according to the embodiment, an electromagnetic warning device is employed as an example.

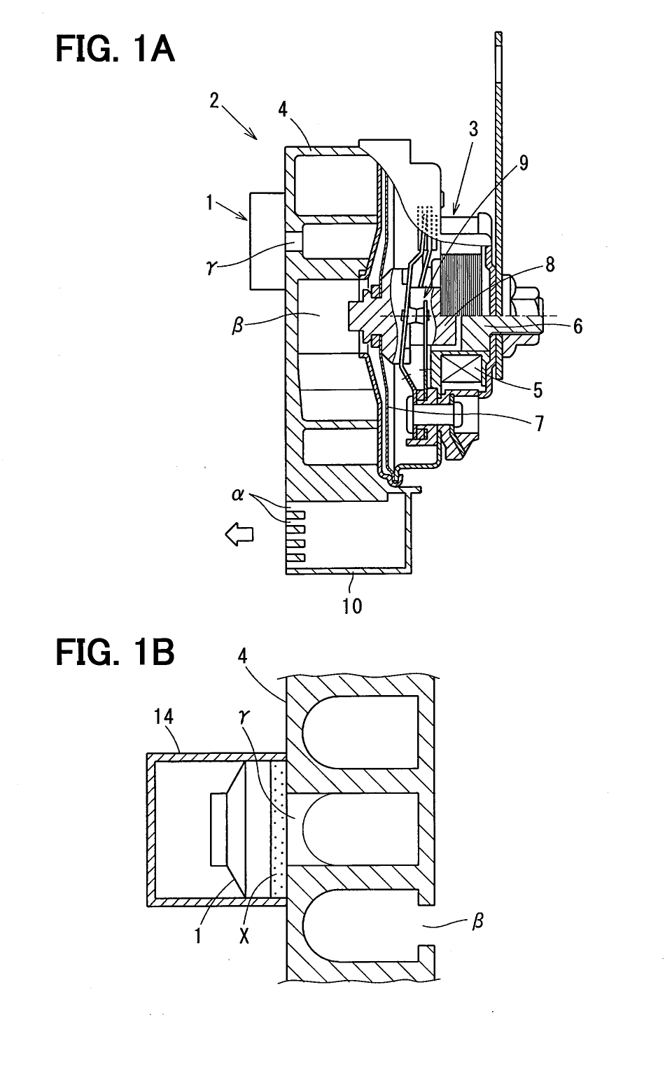

As shown in FIG. 1A, the vehicle horn 2 includes a warning sound generator 3 and a sound tube 4 that has a spiral shape. The warning sound generator 3 produces a resonant frequency which is a source of the resonant warning sound. The sound tube 4 resonates the resonant frequency, and emits the resonant warning sound.

The warning sound generator 3 includes well-known components, such as a coil 5, a fixed iron-core 6, a moveable iron-core 8, and a current interrupter 9. The coil 5 creates magnetic energy when current is applied thereto. The fixed iron core 6 generates a magnetic force that attracts and moves the moveable iron-core 8 toward the fixed iron-core 6. At some point when the moveable iron core 8 reaches the fixed iron core 6, the current interrupter 9 interrupts the current flowing in the coil 5, which stops the generation of the magnetic force and the moveable iron core 8 moves away from the fixed iron core 6. The fixed iron-core 6 may be an attraction core, which creates magnetic attracting force when the magnetic energy is produced by the coil 5. The moveable iron-core 8 is supported at a center of a diaphragm 7 and moves towards the fixed iron-core 6 when the magnetic attracting force is generated. The current interrupter 9 intermittently interrupts the energization current in the coil 5 based on the position of the moveable iron-core 8 relative to the fixed iron-core 6.

The sound tube 4 has a trumpet portion in which a sound passage is enlarged from a horn inlet β to a horn outlet α. The horn inlet β is a sound inlet, and the horn outlet α is a sound outlet. Sound generated by the warning sound generator 3 enters the trumpet portion from the horn inlet β and comes out of the horn outlet α. Moreover, the sound tube 4 is defined by a spiral horn, which is produced by forming the trumpet portion into a spiral shape. An open end of the sound tube 4 defines the horn outlet α.

The warning sound generator 3 is attached to a side face of the sound tube 4, and is arranged to generate the warning sound into the horn inlet β, which is at the center of the sound tube 4. The warning sound generator 3 produces the frequency producing the resonant warning sound. The side face of the sound tube 4 having the warning sound generator 3 is perpendicular to an axis of the spiral shape. For example, when the vehicle horn 2 is attached to the vehicle, the side face of the sound tube 4 faces a rear side of the vehicle.

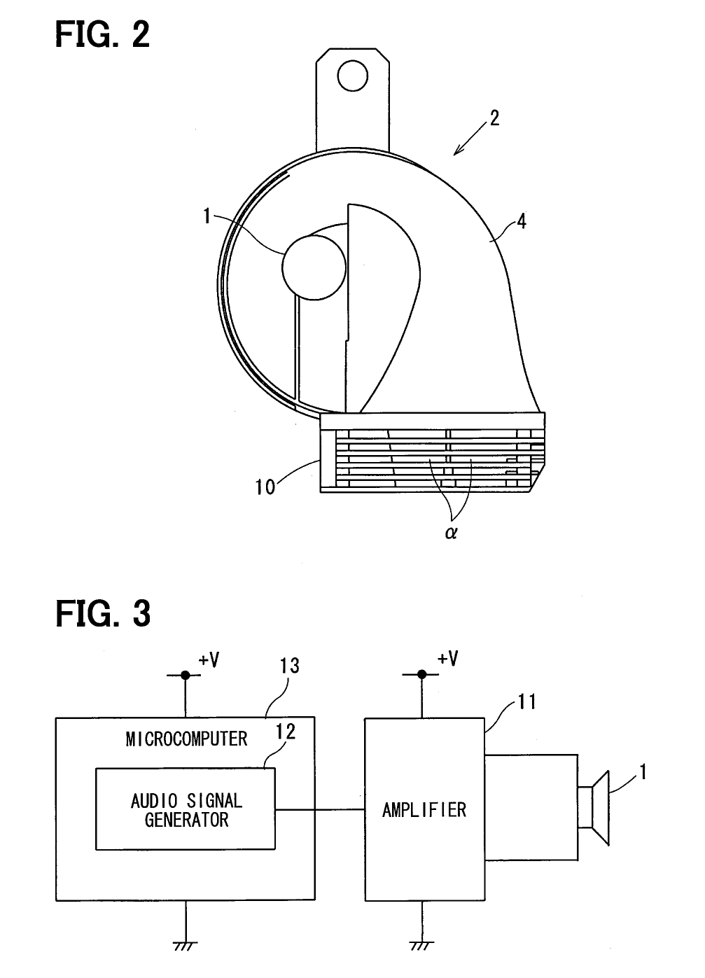

As shown in FIGS. 1A and 2, a directivity controller 10 may be mounted to the horn outlet α of the sound tube 4, but is not limited to the example. When the sound tube 4 emits sound such as the resonant warning sound and the notification sound, the directivity controller 10 controls directivity of the sound to be heard in front of the vehicle.

When a predetermined driving condition to notify pedestrians of an approach of the vehicle is met, the vehicle approach notification unit produces a notification sound, such as artificial engine sound, chord, voice sound and music. As shown in FIG. 3, the vehicle approach notification unit includes the speaker 1, an amplifier 11, and a microcomputer 13. The microcomputer 13 includes an audio signal generator 12 that applies an audio signal, which is a basis of the notification sound, to the amplifier 11. The amplifier 11 actuates the speaker 1, and the speaker 1 produces the notification sound. The audio signal may be an analog signal or a digital signal.

An engine control unit (ECU) inputs a signal, which includes driving vehicle information such as a vehicle speed, to the microcomputer 13. Based on the driving vehicle information, the microcomputer 13 determines whether the predetermined driving condition is met or not to notify pedestrians of the approach of the vehicle. For example, the predetermined driving condition may be the vehicle speed that is under 20 km/h. When the predetermined driving condition is met, the microcomputer 13 actuates the audio signal generator 12 to apply the audio signal to the amplifier 11. The amplifier 11 then actuates the speaker 1 to produce the notification sound.

The amplifier 11 amplifies the audio signal produced by the audio signal generator 12, and actuates the speaker 1 with an amplified audio signal. A B-grade amplifier or a D-grade amplifier can be used as the amplifier 11. By controlling a signal applied to the speaker 1, the amplifier 11 actuates the speaker 1 to produce a frequency that generates the notification sound. In other words, the speaker 1 produces an audible frequency that produces an audible sound.

The speaker 1 is a small speaker which has a few centimeter in diameter such as a magnetic micro speaker that produces a sound wave by magnetic attractive force produced between a permanent magnet and a voice coil such as a magnet coil.

The magnetic micro speaker may be such as a small dynamic cone speaker and a small dynamic domical speaker having a permanent magnet and a voice coil. The voice coil is supported with a diaphragm to vibrate together depending on applied voltage, and produces sound waves, in other words, produces compression air waves.

The speaker 1 is for producing the notification sound to notify pedestrians of the approach of the vehicle. Although the speaker 1 may be required to be mounted on the front side of the vehicle to produce the notification sound forward from the vehicle, it is difficult to have such a space on the front side of the vehicle.

Then, the speaker 1 is disposed to the vehicle horn 2 and produces the notification sound into the sound tube 4, such that the notification sound is emitted out of the vehicle via the sound tube 4.

When the vehicle horn 2 is actuated, the resonant warning sound having a high sound pressure is produced inside the sound tube 4.

Therefore, when the speaker 1 is disposed in the sound tube 4, the resonant warning sound having the high sound pressure impacts the speaker 1, and may break the speaker 1. Furthermore, a back electromotive force produced by the speaker 1 may break a circuit of the amplifier 11 or the like, which actuates the speaker 1.

As shown in FIG. 1B, according to the embodiment, a thin film X partitions a space between the speaker 1 and the sound tube 4.

For example, the speaker 1 is located inside a speaker cavity 14 disposed to the sound tube 4. The sound tube 4 has a through-hole γ, which communicates with the speaker cavity 14 and introduces the notification sound produced by the speaker 1 into the sound tube 4. The thin film X is located to a boundary division between the speaker cavity 14 and the through-hole γ, and partitions the space between the speaker 1 and inside of the sound tube 4.

The thin film X restricts a sound wave having the resonant frequency of the sound tube 4 from passing therethrough, and allows a sound wave having a frequency producing the notification sound to pass the thin film X. The frequency producing the notification sound includes, for example, a part of a frequency range of 600-1000 Hz. Moreover, the thin film X is adjusted to have Young's modulus not to resonate with the resonant frequency, and to transmit the sound wave having the frequency producing the notification sound.

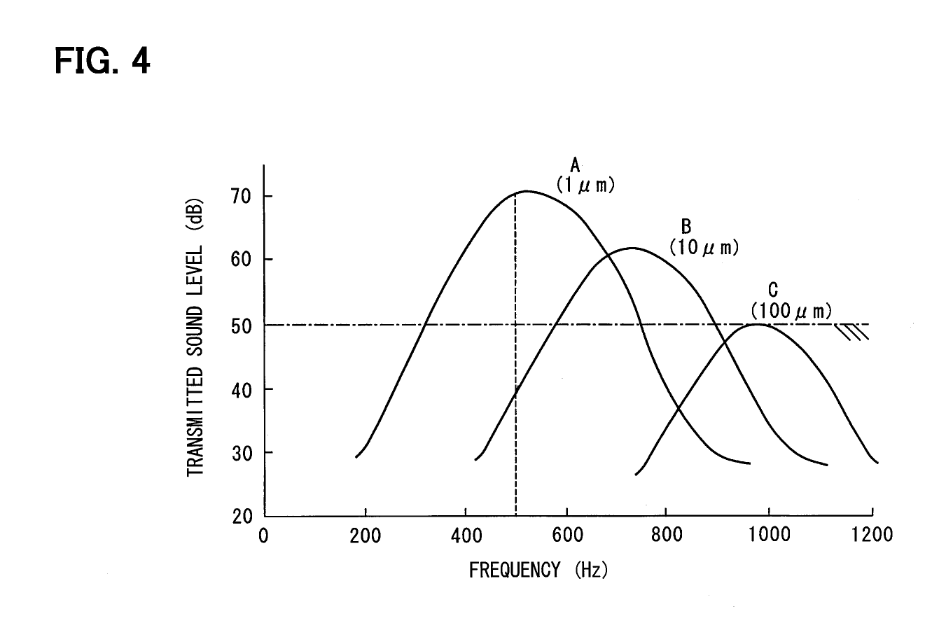

The resonant frequency in the sound tube 4 to which the speaker 1 is attached is set to, for example, 480 Hz. The resonant frequency is shown with a dash line extending vertically in a graph in FIG. 4.

In this case, the thin film X restricts the sound wave with the resonant frequency of 480 Hz from passing therethrough, and transmits at least a part of the frequency range of 600-1000 Hz as the frequency of the notification sound.

For example, a glass-transition temperature of a material making the thin film X may be higher than or equal to 85° C., or at least 65° C. or higher.

Polyethylene naphthalate (PEN), polyimide (PI), polycarbonate (PC), and the like may be applicable to make the thin film X.

PEN is the lowest in cost of PEN, PI, and PC. Therefore, PEN is employed to make the thin film X as an example.

The graph in FIG. 4 shows a relationship between a sound pressure of sound passing through the thin film X and frequencies by changing the thickness of the thin film X made of PEN. A line A, a line B, and a line C in the graph show variations of the sound pressures when the thin film X is 1 μm, 10 μm, and 100 μm in thickness, respectively.

As shown in FIG. 4, when the thin film X is made of PEN, the thickness of the thin film X is set within a range of 10-100 μm to achieve following conditions. The conditions are: the sound wave with the resonant frequency (480 Hz) is restricted from passing through the thin film X; the sound wave including at least a part of the frequency range of 600-1000 Hz is allowed to pass through the thin film X; and a sound pressure of the transmitted sound exceeds a predetermined value, for example, 50 dB shown as a chain line extending horizontally in FIG. 4.

Although the thin film X is made of PEN according to the embodiment, other material may make the thin film X.

Although crystalline polyethylene naphthalate (C-PEN) has a lower glass-transition temperature (69° C.) than PEN, C-PEN is lower in cost than PEN, so C-PEN can be applicable as a material making the thin film X.

The vehicle approach notification unit according to the embodiment has the thin film X that is located to partition the space between the speaker 1 and the sound tube 4. The thin film X restricts the sound wave with the resonant frequency from being transmitted, and allows the sound wave having the frequency of the notification sound to be transmitted.

By having the thin film X, the notification sound produced by the speaker 1 is emitted out of the vehicle via the sound tube 4, and the high sound pressure of the resonant warning sound having an impact on the speaker 1 is reduced.

Therefore, reliability and durability of the speaker 1 mounted to the vehicle horn 2 and the circuit for actuating the speaker 1 are improved. That is, reliability of the vehicle approach notification unit may be improved.

As shown in FIGS. 1A and 2, the speaker 1 is located to distance from the center of the spiral shape of the sound tube 4.

The sound wave with the resonant frequency resonates inside the sound tube 4. The resonant sound wave produces the resonant warning sound. The resonant sound wave has a distribution in sound densities, and is defined to have a dense range and a non-dense range inside the sound tube 4. A mounting location of the speaker 1 to the sound tube 4 is set in the non-dense range. The mounting location of the speaker 1 corresponds to the location of the through-hole γ.

That is, the resonant warning sound in the dense range is restricted from reaching the thin film X, and the resonant warning sound in the non-dense range having low sound energy (i.e., a low sound pressure) reaches the thin film X. Thus, the sound pressure of the resonant warning sound transmitted to the speaker 1 through the thin film X can be reduced.

Therefore, breakage of the speaker 1 and the circuit caused by the resonant warning sound produced inside the sound tube 4 is restricted securely, and the reliability of the speaker 1 and the circuit is increased.

To sum up, the vehicle approach notification unit of the above embodiment can be described as follows.

The vehicle approach notification unit has the speaker 1 which produces the notification sound when the predetermined driving condition is met. The speaker 1 and the warning sound generator 3 are separately disposed in the vehicle, and the speaker 1 is disposed at the sound tube 4 so that the speaker 1 emits the notification sound into the sound tube 4, and the notification sound is emitted out via the sound tube 4.

The thin film X partitions the space (i.e., a junction part) between the speaker 1 and the sound tube 4. The thin film X restricts the resonant frequency resonated in the sound tube 4 from passing through the thin film X, and transmits the frequency producing the notification sound. Therefore, the notification sound produced by the speaker 1 is emitted out from the vehicle via the sound tube 4, and the sound pressure of the resonant warning sound affecting the speaker 1 may be reduced.

Although the sound tube 4 has one speaker 1 according to the embodiment, the sound tube may mount a plurality of the speakers 1 to enhance a sound pressure of the notification sound.

Although the magnetic micro speaker is employed as an example of the speaker 1 according to the embodiment, other small speakers, which are small in diameter and emit audible sound directly such as a piezoelectric speaker, may be applicable.

When the warning sound generator 3 is actuated, the speaker 1 may be actuated at the same time. In such a case, a tone of the resonant warning sound may be controlled by actuating the speaker 1.

When the speaker 1 produces the notification sound, the warning sound generator 3 may be actuated as a dynamic speaker without actuating the current interrupter 9 intermittently. In such a case, the speaker 1 and the warning sound generator 3 produce notification sounds at the same time.

Such changes and modifications are to be understood as being within the scope of the present disclosure as defined by the appended claims.

What is claimed is:

1. A vehicle approach notification unit disposed in a vehicle for producing a notification sound, the vehicle approach notification unit comprising;
a speaker disposed to a sound tube of a vehicle horn of the vehicle, the vehicle horn producing a resonant warning sound with a resonant frequency; and
a thin film which partitions a space between the speaker and the sound tube, wherein
the speaker emits the notification sound into the sound tube so that the notification sound is emitted outside of the vehicle via the sound tube, and
the thin film restricts a sound wave having the resonant frequency from being transmitted, and allows a sound wave having a frequency producing the notification sound to be transmitted.

2. The vehicle approach notification unit according to claim 1, wherein
the thin film is adjusted to have Young's modulus so that the sound wave having the resonant frequency is restricted from passing through the thin film and that the sound wave having the frequency producing the notification sound is allowed to pass through the thin film.

3. The vehicle approach notification unit according to claim 1, wherein
the thin film is made of polyethylene naphthalate, and has a thickness in a range of 10-100 μm.

4. The vehicle approach notification unit according to claim 1, wherein
the sound tube has a spiral shape,
the resonant warning sound has a non-dense range and a dense range inside the sound tube, and
the speaker is located in the non-dense range and positioned to distance from a center of the spiral shape.
